(19) United States
(12) Patent Application Publication
(10) Pub. No.: US 2016/0028488 A1
(43) Pub. Date: Jan. 28, 2016

(54) OPTICAL TRANSCEIVER

(71) Applicant: OPTO ELECTRONICS SOLUTIONS CO., LTD., Gwangju (KR)

(72) Inventor: Joon Sang YU, Gyeonggi-do (KR)

(21) Appl. No.: 14/446,936

(22) Filed: Jul. 30, 2014

(30) Foreign Application Priority Data
Jul. 28, 2014 (KR) 10-2014-0095752

(51) Int. Cl. H04B 10/40

(52) U.S. Cl. CPC H04B 10/40

(57) ABSTRACT

Disclosed is an optical transceiver. The optical transceiver that accesses each port of a network device includes: a recognition unit recognizing an optical transceiver that accesses another port of the network device; a message exchange unit exchanging a message with the optical transceiver that accesses another port; a time stamping unit recording time stamps for an input time and an output time of the message in the message; and a synchronization control unit performing time synchronization for a master optical transceiver by calculating an offset time and a network delay time by using the time stamps recorded in the exchanged message.

### TECHNICAL FIELD

The present invention relates to an optical transceiver used in optical communications.

### BACKGROUND ART

In general, an optical transceiver is a device that accommodates various optical communication functions in one package to modularize various optical communication functions to be connected with optical fibers. In recent years, as the optical transceiver, a bidirectional optical transceiver in which an optical transmitter using, as a light source, a laser diode which has low power consumption and is usable in a long distance and an optical receiver that performs optical communications by using a photodiode are modularized into one is primarily used.

In recent years, technological development to implement various operation administration maintenance (OAM) functions of which the optical transceiver take charge in an optical communication system in a module level in addition to a basic function of the existing optical transceiver has been actively progressed.

Meanwhile, in recent years, a lot of researches into multimedia data transmission technology on a communication network have been made while multimedia data occupies a large weight on a home network. A least jitter allowance value and strict service quality (QoS) should be ensured for the data sensitive to time.

An initial 4^{th} generation wireless network uses a frequency division duplex (FDD) scheme. In FDD communication, frequencies among respective LTE base stations are synchronized. One of methods of increasing a bandwidth of an LTE network is converting the FDD into time division duplex (TDD) and in TDD communication, a time of day (ToD) among the LTE base stations should be time and phase-synchronized within 1.5 microseconds.

In order to synchronize the LTE base stations in the TDD communication scheme, intermediate network devices thereamong should also support the time and phase synchronization. For recent 10 years, most Ethernet networks support frequency-synchronized synchronous Ethernet (SyncE). In order for the networks to support the time and phase synchronization, a new expensive device should be introduced or the device should be upgraded so as to support the time and phase synchronization.

### SUMMARY OF THE INVENTION

The present invention has been made in an effort to provide IEEE1588 synchronization for a data packet exchanged among respective ports of a network device by replacing only an optical transceiver without replacing the network device or upgrading hardware to make the optical transceiver access the network device.

The present invention has also been made in an effort to provide an optical transceiver that can cost-efficiently support a network supported only on synchronous Ethernet in the related art at low cost by implementing an IEEE1588 transparent clock in the optical transceiver.

An exemplary embodiment of the present invention provides an optical transceiver that accesses each port of a network device, including: a recognition unit recognizing an optical transceiver that accesses another port of the network device; a message exchange unit exchanging a message with the optical transceiver that accesses another port; a time stamping unit recording time stamps for an input time and an output time of the message in the message; and a synchronization control unit performing time synchronization for a master optical transceiver by calculating an offset time and a network delay time by using the time stamps recorded in the exchanged message.

The recognition unit may recognize the optical transceiver that accesses another port of the network device by transmitting a test packet.

The message exchange unit may compare a protocol of a response packet to the test packet to exchange a message with an optical transceiver matched by the protocol.

The message exchange unit may exchange the message with an optical transceiver that supports an IEEE1588 protocol.

The optical transceiver that accesses the network device may operate at the same system clock.

The master optical transceiver may be selected among a plurality of optical transceivers that accesses each port of the network device.

According to exemplary embodiments of the present invention, an optical transceiver accesses a network device to synchronize a data packet exchanged among respective ports of the network device without replacing the network device or upgrading hardware.

### BRIEF DESCRIPTION OF THE DRAWINGS

FIG. 1 is a connection configuration diagram of an optical transceiver according to an exemplary embodiment of the present invention.

FIG. 2 is a configurable block diagram of the optical transceiver according to the exemplary embodiment of the present invention.

FIG. 3 is a conceptual diagram for describing an operation of an optical transceiver according to an exemplary embodiment of the present invention.

FIG. 4 is a conceptual diagram of an operation sequence of the optical transceiver according to the exemplary embodiment of the present invention.

### DETAILED DESCRIPTION

The present invention may have various modifications and various exemplary embodiments and specific exemplary embodiments will be illustrated in the drawings and described. However, this does not limit the present invention to specific exemplary embodiments, and it should be understood that the present invention covers all the modifications, equivalents and replacements within the idea and technical scope of the present invention.

Terms including an ordinal number such as first or second may be used to describe various components but the components are not limited by the above terms. The above terms are used only to discriminate one component from the other component. For example, without departing from the scope of the present invention, a second component may be referred to as a first component, and similarly, the first component may be referred to as the second component. A terminology such as and/or includes a combination of a plurality of associated items or any item of the plurality of associated items.

It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, it is understood that no element is not present between the element and the other element.

Terms used in the present application are used only to describe specific exemplary embodiments, and are not intended to limit the present invention. A singular form may include a plural form if there is no clearly opposite meaning in the context. In the present application, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations, in advance.

If it is not contrarily defined, all terms used herein including technological or scientific terms have the same meaning as those generally understood by a person with ordinary skill in the art. It should be understood that terms defined in a generally used dictionary have the same meanings as contextual meanings of associated techniques and if not apparently defined in this application, the terms should not be interpreted as ideological or excessively formal meaning.

Hereinafter, exemplary embodiments of the present invention will be described in detail with reference to the accompanying drawings, in which like reference numerals refer to like or similar elements regardless of reference numerals and a duplicated description thereof will be omitted.

FIG. 1 is a connection configuration diagram of an optical transceiver according to an exemplary embodiment of the present invention. Referring to FIG. 1, a network device 200 according to the exemplary embodiment of the present invention as a communication device that connects network units constituting a network may be constituted by, for example, a switch, a router, a hub, and the like.

Optical transceivers 110 to 160 according to the exemplary embodiment of the present invention may mean various types of optical transceiver modules including an SFP, an XFP, and the like and all types of optical transceiver modules may be used, which may convert an optical signal into an electric signal and provide the electric signal to a host system or convert the electric signal into the optical signal and provide the optical signal to the outside through optical fibers.

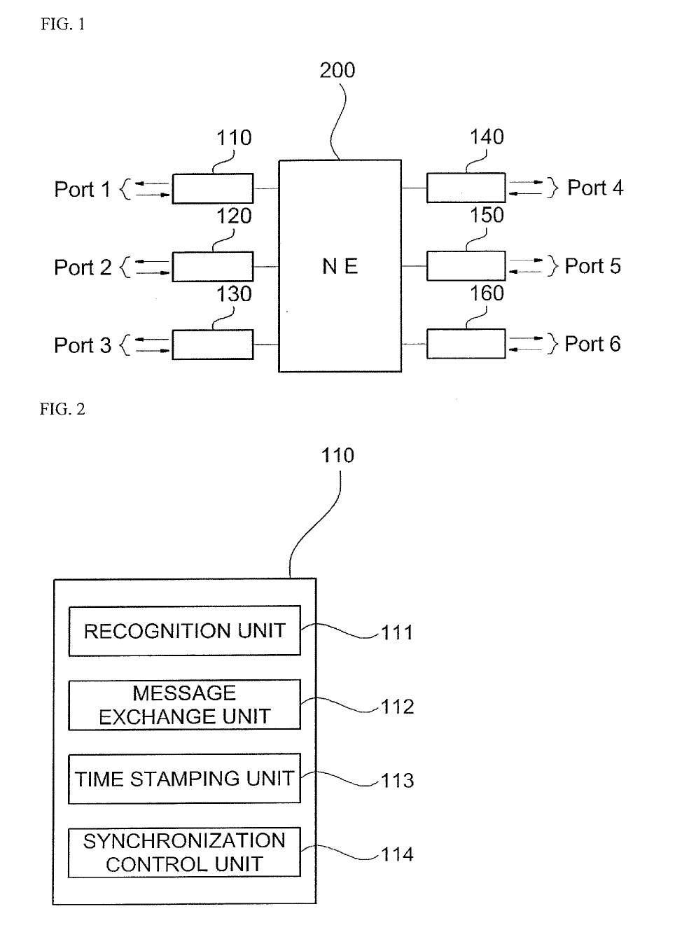

FIG. 2 is a configurable block diagram of the optical transceiver according to the exemplary embodiment of the present invention.

Referring to FIG. 2, the optical transceiver 110 according to the exemplary embodiment of the present invention may access each port of the network device and be configured to include a recognition unit 111, a message exchange unit 112, a time stamping unit 113, and a synchronization control unit 114.

The recognition unit 111, the message exchange unit 112, the time stamping unit 113, and the synchronization control unit 114 may be implemented by using an FPGA in the optical transceiver 110 according to the exemplary embodiment of the present invention.

According to the exemplary embodiment of the present invention, optical transceivers that access the same network device 200 may operate according to the same system clock and when the system clock is not supported, a phase locked loop (PLL) circuit is added to support a function of the system clock.

The recognition unit 111 may recognize an optical transceiver that accesses another port of the network device 200. For example, when the recognition unit 111 transmits a test packet to another port and receives a response packet thereto, the recognition unit 111 may recognize the optical transceiver that accesses another port by analyzing the response packet. In this case, the test packet and the response packet may be transmitted and received through transmission and reception paths of a general data packet of the network device 200.

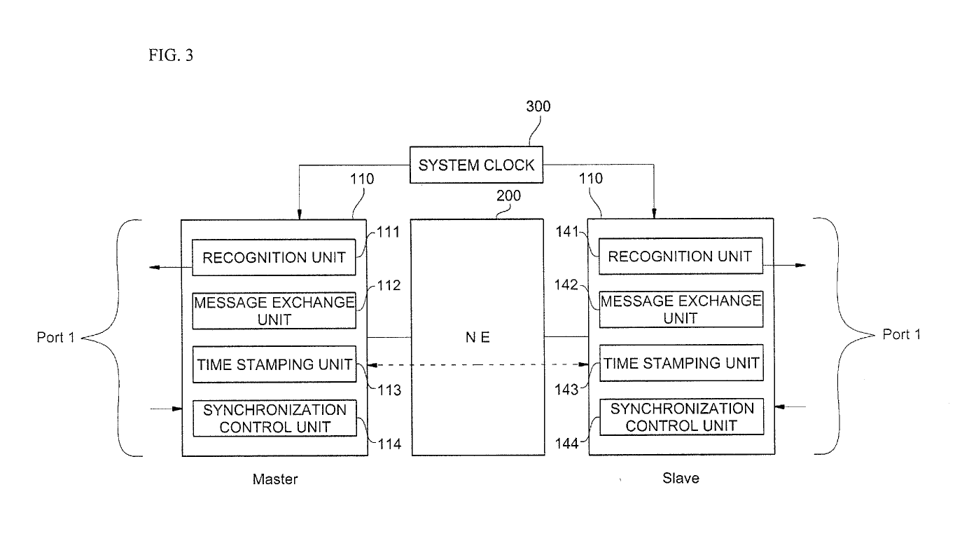

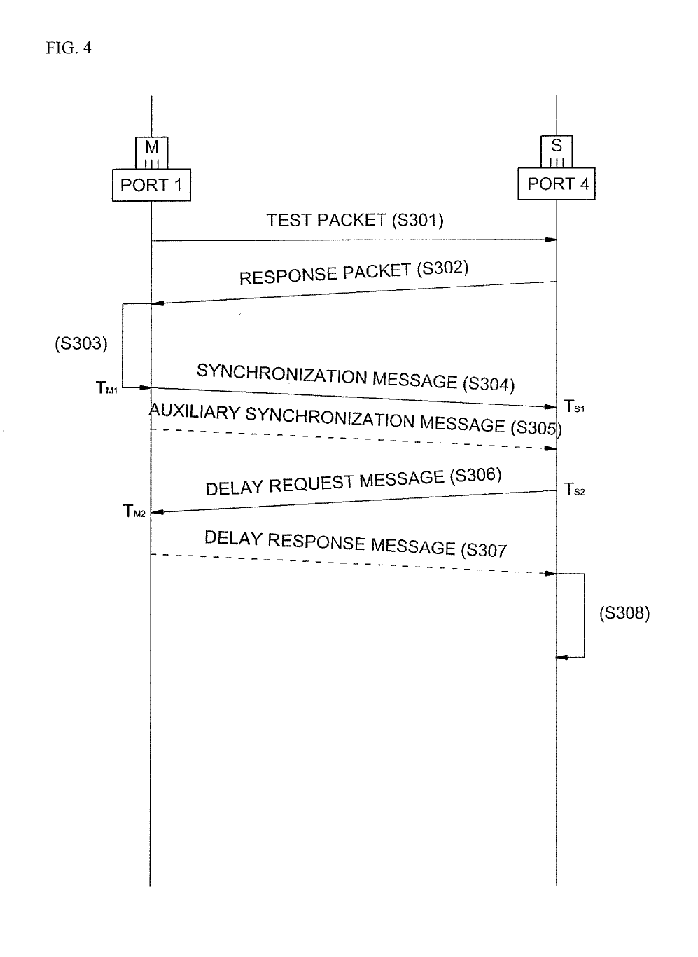

The message exchange unit 112 may exchange a message with the optical transceiver that accesses another port. The message exchange unit 112 may determine whether a protocol of the response packet to the test packet transmitted by the recognition unit 111 supports an IEEE1588 protocol and exchange the message with the optical transceiver that transmits the response packet that supports the IEEE1588 protocol. The message exchanged by the message exchange unit 112 may include a synchronization message, an auxiliary synchronization message, a delay request message, and a delay response message, and will be described in detail in FIGS. 3 and 4.

That is, the recognition unit 111 first searches for the optical transceiver that accesses another port of the network device 200 and recognizes the relevant optical transceiver and the message exchange unit 112 determines whether the accessed optical transceiver is capable of supporting the IEEE1588 protocol. Accordingly, the optical transceiver 110 according to the exemplary embodiment of the present invention performs a synchronization process by determining the optical transceiver which may support the IEEE1588 protocol among optical transceivers that access the network device 200.

Any one of the optical transceivers that support the IEEE1588 protocol may be selected as a master optical transceiver. The optical transceiver selected as the master optical transceiver provides a reference time to a slave optical transceiver which is not selected. A selection criterion of the master optical transceiver may be arbitrarily changed according to a set-up and for example, the master optical transceiver may be set to be selected according to a priority of a port number.

The time stamping unit 113 may record a time stamp for an input time and an output time of the message in the message. The time stamping unit 113 records the output time of the message at the time of transmitting the message to the optical transceiver that accesses another port and the input time of the message at the time of receiving the message from another port.

The synchronization control unit 114 may perform time synchronization for the master optical transceiver by calculating an offset time and a network delay time by using the time stamp recorded in the exchanged message.

FIG. 3 is a conceptual diagram for describing an operation of an optical transceiver according to an exemplary embodiment of the present invention. FIG. 4 is a conceptual diagram of an operation sequence of the optical transceiver according to the exemplary embodiment of the present invention.

Referring to FIGS. 3 and 4, first, the optical transceiver 110 that accesses a first port Port1 of the network device transmits a test packet to an optical transceiver that accesses a fourth port Port4 (S301).

The optical transceiver that receives the test packet replies the response packet in response thereto (S302).

The optical transceiver that receives the response packet determines whether the response packet supports the IEEE1588 protocol. The optical transceivers of the first port and the fourth port select the optical transceiver that accesses the first port as the master optical transceiver. A criterion for selection as the master optical transceiver may be arbitrarily changed according to the set-up, but in the exemplary embodiment, selecting the optical transceiver that accesses a port having a high priority as the master optical transceiver will be described as one example (S303).

Hereinafter, the optical transceiver of the first port and the optical transceiver of the fourth port will be described as the master optical transceiver and the slave optical transceiver, respectively.

The master optical transceiver 110 transmits the synchronization message to the slave optical transceiver 140. The time stamp at the time of outputting the synchronization message is recorded in the synchronization message and the slave optical transceiver 140 records the time stamp at the time of inputting the synchronization message. The time of the time stamp is recorded based on a reference time provided by the master optical transceiver 110.

The master optical transceiver 110 transmits the auxiliary synchronization message to the slave optical transceiver 140. The time stamp at the time of outputting the synchronization message is recorded in the auxiliary synchronization message to improve accuracy (S305).

The slave optical transceiver 140 transmits a delay request message to the master optical transceiver 110. A time stamp at the time of outputting the delay request message is recorded in the delay request message and the master optical transceiver 110 records a time stamp at the time of inputting the delay request message. The time of the time stamp is recorded based on the reference time provided by the master optical transceiver 110 (S306).

The master optical transceiver 110 transmits a delay response message to the slave optical transceiver 140. The time stamp at the time of inputting the delay request message is recorded in the delay response message to be transmitted (S307).

The slave optical transceiver 140 performs synchronization for the master optical transceiver 110 by using information on the time stamp recorded in the message exchanged with the master optical transceiver 110. The slave optical transceiver 140 calculates an offset time and a network delay time by using the time stamp information and performs time synchronization by adjusting time information (time of network element) by using a calculation result value. The offset time and the network delay time may be calculated by Equations 1 and 2 below.

[Equation 1]

Network delay time={(Tₘ₂−Tₘ₁)−(Tₛ₂−Tₛ₁)}/2

[Equation 2]

Offset time=Tₛ₁−Tₘ₁−(network delay time)

According to exemplary embodiments of the present invention, an optical transceiver accesses a network device to synchronize a data packet exchanged among respective ports of network devices without replacing the network device or upgrading hardware.

A term of ‘unit’ used in the exemplary embodiment means software or a hardware component such as a field-programmable gate array (FPGA) or ASIC, and ‘unit’ performs predetermined roles. However, ‘unit’ is not a meaning limited to software or hardware. ‘Unit’ may be configured to be positioned in an addressable storage medium and configured to regenerate one or more processors. Therefore, as one example, ‘unit’ includes components such as software components, object oriented software components, class components, and task components, processes, functions, attributes, procedures, subroutines, segments of a program code, drivers, firmware, a microcode, a circuit, data, a database, data structures, tables, arrays, and variables. Functions provided in the components and ‘units’ may be joined as a smaller number of components or further separated into additional components and ‘units’. The components and ‘units’ may be implemented to regenerate one or more CPUs within a device or a security multimedia card.

The present invention has been described in detail with reference to preferred embodiments thereof. However, it will be appreciated by those skilled in the art that various modifications and changes can be made within the scope without departing from the spirit and the area which are defined in the appended claims and their equivalents.

What is claimed is:

1. An optical transceiver that accesses each port of a network device, comprising:
a recognition unit recognizing an optical transceiver that accesses another port of the network device;
a message exchange unit exchanging a message with the optical transceiver that accesses another port;
a time stamping unit recording time stamps for an input time and an output time of the message in the message; and
a synchronization control unit performing time synchronization for a master optical transceiver by calculating an offset time and a network delay time by using the time stamps recorded in the exchanged message.

2. The optical transceiver of claim 1, wherein the recognition unit recognizes the optical transceiver that accesses another port of the network device by transmitting a test packet.

3. The optical transceiver of claim 2, wherein the message exchange unit compares a protocol of a response packet to the test packet to exchange a message with an optical transceiver matched by the protocol.

4. The optical transceiver of claim 3, wherein the message exchange unit exchanges the message with an optical transceiver that supports a transparent clock (IEEE1588 transparent clock) of an IEEE1588 protocol.

5. The optical transceiver of claim 1, wherein the optical transceiver that accesses the network device operates at the same system clock.

6. The optical transceiver of claim 1, wherein the master optical transceiver is selected among a plurality of optical transceivers that accesses each port of the network device.
